(19) United States
(12) Patent Application Publication
(10) Pub. No.: US 2026/0211253 A1
(43) Pub. Date: Jul. 23, 2026

(54) OPTICAL ENGINE STRUCTURE AND ASSEMBLY METHOD OF OPTICAL ENGINE STRUCTURE

(71) Applicant: TRIPLE WIN TECHNOLOGY(SHENZHEN) CO.LTD., Shenzhen (CN)

(72) Inventor: HUNG-LUNG HO, New Taipei (TW)

(21) Appl. No.: 19/440,498

(22) Filed: Jan. 5, 2026

(30) Foreign Application Priority Data
Jan. 22, 2025 (CN) 202520152325.5

(51) Int. Cl. G02B 27/10

(52) U.S. Cl. CPC G02B 27/1073

(57) ABSTRACT

An optical engine structure including a display for emitting image light, a light-combining element, a lens assembly, a mounting frame and a first connecting structure. The light-combining element is used to receive the image light and change an optical path of the image light. The lens assembly is located on one side of a light-emitting surface of the light-combining element to modulate and emit the image light from the light-emitting surface. The mounting frame includes an installation space for receiving the light-combining element , a light-emitting port and a light-entering port. The first connecting structure is fixed to the light-emitting port of the mounting frame and has a first opening connecting the light-emitting port. Optical axes of the lens assembly and the light-combining element are coincident, and centers of the first opening and the light-emitting port are both located on the optical axis of the lens assembly.

### CROSS-REFERENCE TO RELATED APPLICATION

The present disclosure is based on Chinese patent application with application numbers 202520152325.5, filed on January 22, 2025, and titled “OPTICAL ENGINE STRUCTURE”, and claims priority to this Chinese patent application, the contents of which are hereby incorporated by reference.

### FIELD

The subject matter herein generally relates to an optical engine structure and an assembly method of optical engine structure.

### BACKGROUND

Display devices using Augmented Reality (AR) technology (referred to as AR display devices) combine virtual images with real scenes, allowing users to interact naturally with digital content and have become a development goal of the industry. When these display devices show images, display panels, lenses and other structures need to be assembled and coordinate each other to form an optical engine structure for use. How to solve the assembly problem of display panels, lenses and other structures is one of the urgent problems to be solved.

### BRIEF DESCRIPTION OF THE DRAWINGS

FIG. 1 is a schematic diagram illustrating an optical engine structure according to an embodiment of the present disclosure.

FIG. 2 is an exploded view illustrating an optical engine structure according to an embodiment of the present disclosure.

FIG. 3 is a cross-sectional view illustrating the optical engine structure of FIG. 1, taken along a view line of III-III line.

FIG. 4 is a schematic diagram illustrating a positional relationship between a light-combining element, a mounting frame and a second connecting structure of FIG. 1.

FIG. 5 is a schematic diagram illustrating a mounting frame according to an embodiment of the present disclosure.

FIG. 6 is a schematic diagram illustrating the mounting frame of FIG. 5 from another perspective.

FIG. 7 is a flowchart of an assembly method of an optical engine structure according to an embodiment of the present disclosure

### DETAILED DESCRIPTION

It will be appreciated that for simplicity and clarity of illustration, where appropriate, reference numerals have been repeated among the different figures to indicate corresponding or analogous components. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The disclosure is illustrated by way of example and not by way of limitation in the figures of the accompanying drawings, in which like references indicate similar components. It should be noted that references to “an” or “one” embodiment in this disclosure are not necessarily to the same embodiment, and such references mean “at least one.”

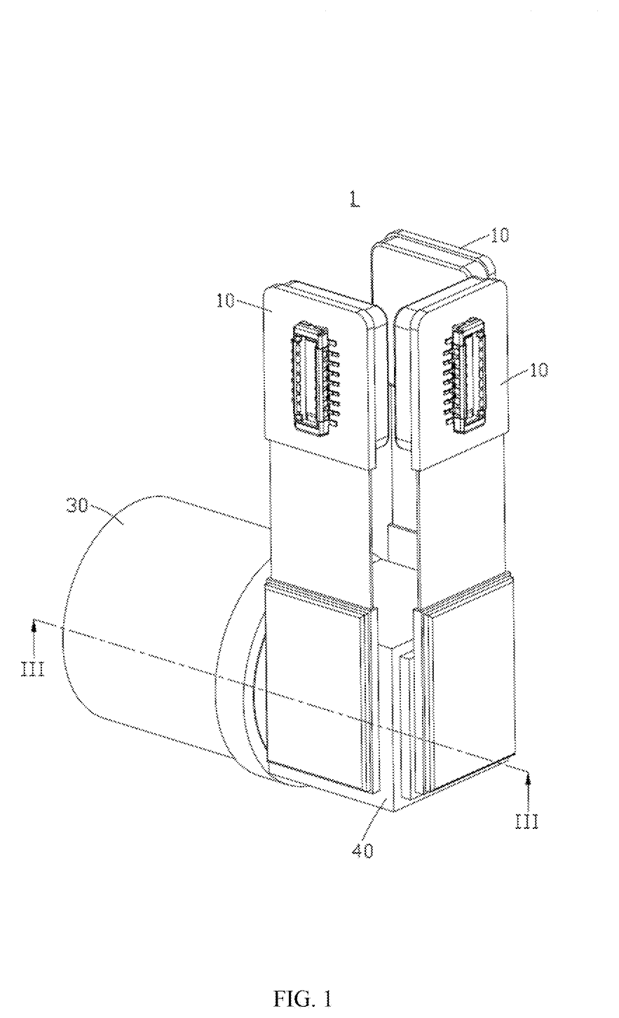

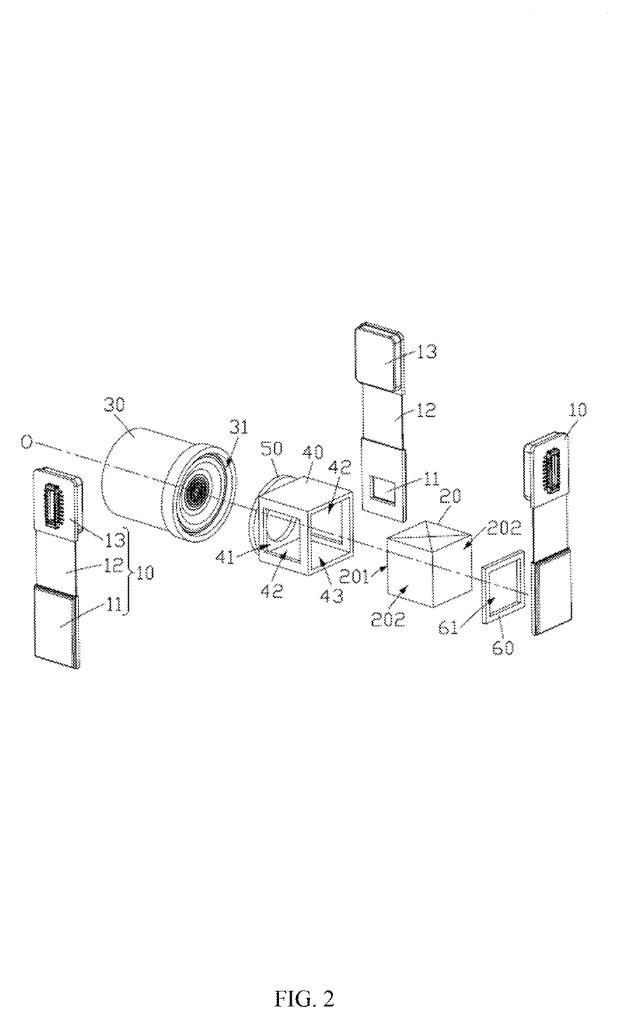

FIG. 1 illustrates an embodiment of an optical engine structure 1. Referring to FIG. 1 and FIG. 2, the optical engine structure 1 includes a display 10, a light-combining element 20, a lens assembly 30, a mounting frame 40, and a first connecting structure 50. The display 10 is configured for emitting image light. The light-combining element 20 includes a light-emitting surface 201 and a light-entering surface 202. The light-combining element 20 is configured for receiving the image light and changing an optical path of the image light, so that the image light emitted from the display 10 enters the lens assembly 30. The lens assembly 30 is located on a side of the light-combining element 20 having the light-emitting surface 201 and is configured for modulating the image light from the light-emitting surface 201 and then emitting the modulated image light.

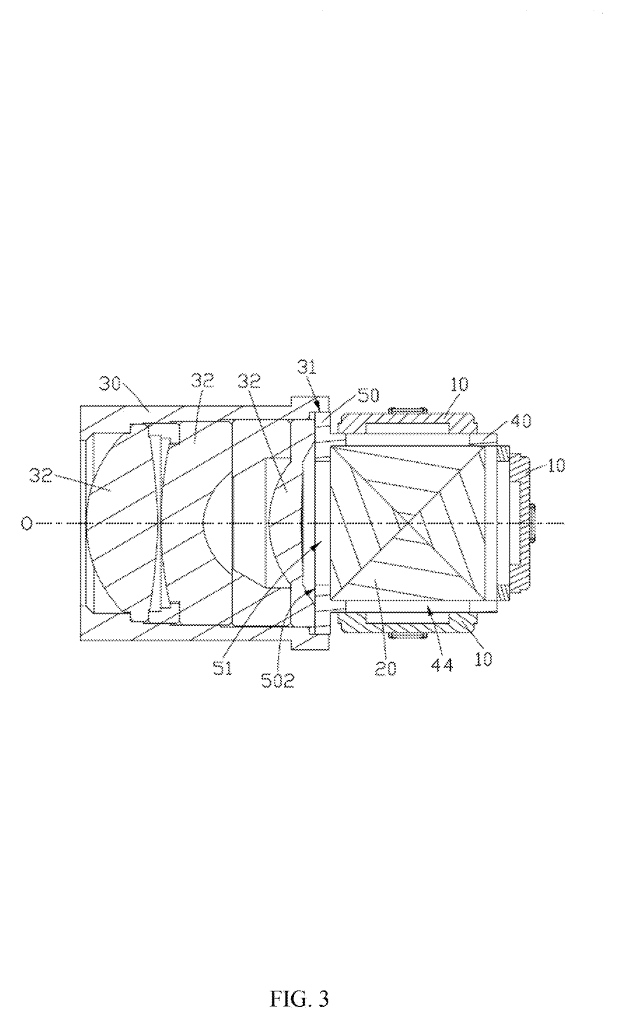

Referring to FIG. 3, the lens assembly 30 is configured for collimating the image light. The lens assembly 30 includes multiple lenses 32, and optical axes of the multiple lenses 32 are coincident. The multiple lenses 32 include at least one glass lens, at least one plastic lens, or at least one metalens. A shape of each of a light-entering surface and a light-emitting surface of each of the multiple lenses 32 may be spherical or aspherical.

An end of the lens assembly 30 facing the first connecting structure 50 includes a slot 31, and the first connecting structure 50 is engaged in the slot 31. A shape of the slot 31 may be annular, and a shape of an area surrounded by an outer contour of the first connecting structure 50 may be circular. An inner wall of the slot 31 is in contact with an outer edge of the first connecting structure 50 to connect the lens assembly 30 and the mounting frame 40. The inner wall of the slot 31 abuts against the outer edge of the first connecting structure 50.

The mounting frame 40 includes an installation space 44 and further includes a light-emitting port 41 and a light-entering port 42 that are in communication with the installation space 44. The light-combining element 20 is located in the installation space 44, the light-emitting surface 201 is exposed from the light-emitting port 41 and the light-entering surface 202 is exposed from the light-entering port 42. The first connecting structure 50 is fixedly connected to the light-emitting port 41 of the mounting frame 40, and the first connecting structure 50 has a first opening 51 in communication with the light-emitting port 41. When the first connecting structure 50 is engaged with the lens assembly 30, the first connecting structure 50 is engaged in the slot 31, a center of the slot 31 and a center of the first opening 51 are located on an optical axis O of the lens assembly 30, and a center of the light-emitting port 41 is also located on the optical axis O. Therefore, a center of the lens assembly 30 is aligned with the center of the light-emitting port 41, the optical axis O of the lens assembly 30 coincides with an optical axis of the light-combining element 20, and the centers of the first opening 51 and the light-emitting port 41 are both located on the optical axis O of the lens assembly 30. The mounting frame 40 and the first connecting structure 50 may be integrally formed.

The mounting frame 40 further includes an installation port 43 in communication with the installation space 44. The light-combining element 20 may be assembled into the installation space 44 through the installation port 43. The light-combining element 20 is filled in the installation space 44. The mounting frame 40 can protect the light-combining element 20, which is beneficial to prevent the light-combining element 20 from being damaged during use, thereby improving the overall strength and durability of the optical engine structure 1.

In some embodiments, an area of a cross-section of the light-combining element 20 perpendicular to the optical axis O may be less than or equal to an area of the installation port 43, and a volume of the light-combining element 20 may be equal to a volume of the installation space 44.

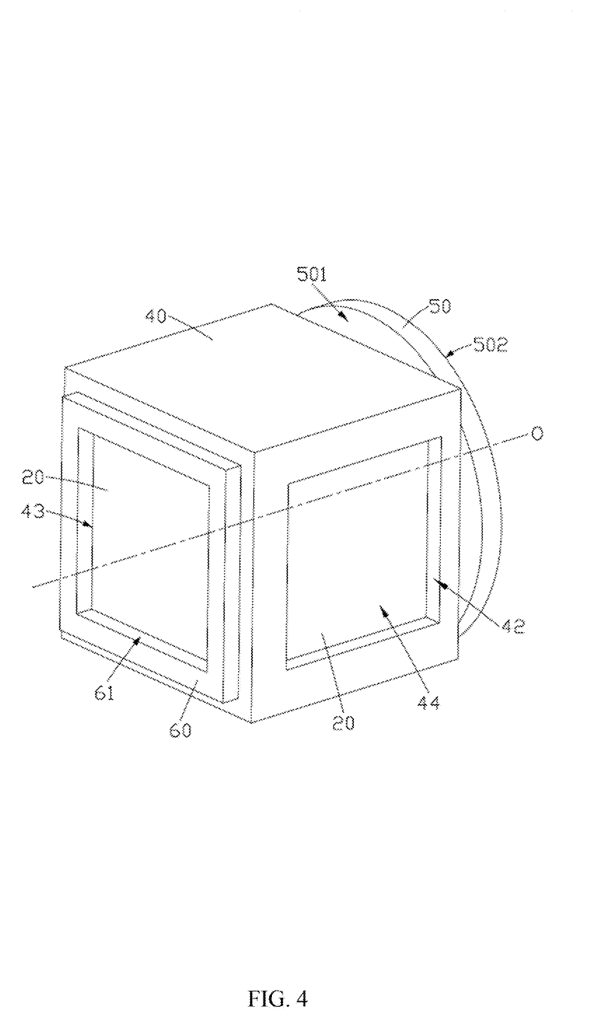

Referring to FIG. 4, the optical engine structure 1 may further include a second connecting structure 60. The second connecting structure 60 is fixedly connected to the installation port 43 and includes a second opening 61 in communication with the installation port 43, and an area of the second opening 61 is less than an area of the installation port 43. The second connecting structure 60 is configured for fixing the light-combining element 20 in the installation space 44 and prevent the light-combining element 20 from leaving the installation space 44 through the installation port 43.

In some embodiments, referring to FIG. 2, the optical engine structure 1 may include three displays 10, and each display 10 is used to emit monochromatic image light, and colors of the image light emitted by the displays 10 are different. Each display 10 may be a micro light-emitting diode (μLED) display, an organic light-emitting diode (OLED) display or a micro organic light-emitting diode (μOLED) display. The three displays 10 are respectively used for emitting red, green and blue image light.

Each display 10 includes a display portion 11, a circuit board 12 and a connector portion 13. The display portion 11 is located on a side of the mounting frame 40 having the light-entering port 42. One end of the circuit board 12 is electrically connected to the display portion 11, and another end is electrically connected to the connector portion 13. The connector portion 13 is electrically connected to an external power supply or a signal source to input electrical signals to the display portion 11, thereby enabling the display portion 11 to emit image light.

In some embodiments, in the mounting frame 40, the number of light-emitting ports 41 may be one, the number of light-entering ports 42 may be two, and the number of installation ports 43 may be one. The shapes of the light-emitting port 41, the light-entering ports 42 and the installation port 43 may be rectangular. In the light-combining element 20, the number of light-emitting surfaces 201 is one, and the number of light-entering surfaces 202 is three. The light-emitting surface 201 and the three light-entering surfaces 202 are four non-coplanar sides of the light-combining element 20. Among them, two light-entering surfaces 202 of the three light-entering surfaces 202 are parallel and spaced apart from each other, and the light-emitting surface 201 and a remaining light-entering surface 202 of the three light-entering surfaces 202 are located between the two light-entering surfaces 202 and are parallel and spaced apart from each other. When the light-combining element 20 is located in the installation space 44, the light-emitting surface 201 is exposed from the light-emitting port 41, the two light-entering surfaces 202 are respectively exposed from the two light-entering ports 42, and the remaining light-entering surface 202 is exposed from the installation port 43 and the second opening 61. In some embodiments, the mounting frame 40 may be a cubic structure with the installation space 44 formed at the center, and the light-combining element 20 may be a cube. In other embodiments, the mounting frame 40 may be a cuboid structure with the installation space 44 formed at the center, and the light-combining element 20 may be a cuboid.

The display portions 11 of the three displays 10 are respectively connected to three sides of the mounting frame 40. The display portions 11 of two displays 10 of the three displays 10 are respectively fixedly connected to the sides of the mounting frame 40 having the light-entering ports 42, and the two light-entering surfaces 202 of the light-combining element 20 are respectively exposed from the two light-entering ports 42, so that the image light emitted by the two display portions 11 can pass through the two light-entering surfaces 202 and enter the light-combining element 20. The display portion 11 of a remaining display 10 of the three displays 10 is fixedly connected to the second connecting structure 60. The second connecting structure 60 is fixed at the installation port 43 and has a second opening 61 communicating with the installation port 43. The remaining light-entering surface 202 of the light-combining element 20 is exposed from the installation port 43 and the second opening 61, so that the image light emitted by the display portion 11 can pass through the remaining light-entering surface 202 and enter the light-combining element 20.

In some embodiments, the number of displays 10 may be two, and the display portions 11 of the two displays 10 are respectively fixedly connected to the two sides of the mounting frame 40 having the light-entering ports 42, or one display 10 is fixedly connected to the side of the mounting frame 40 having the light-entering port 42, and the other display 10 is fixedly connected to the second connecting structure 60.

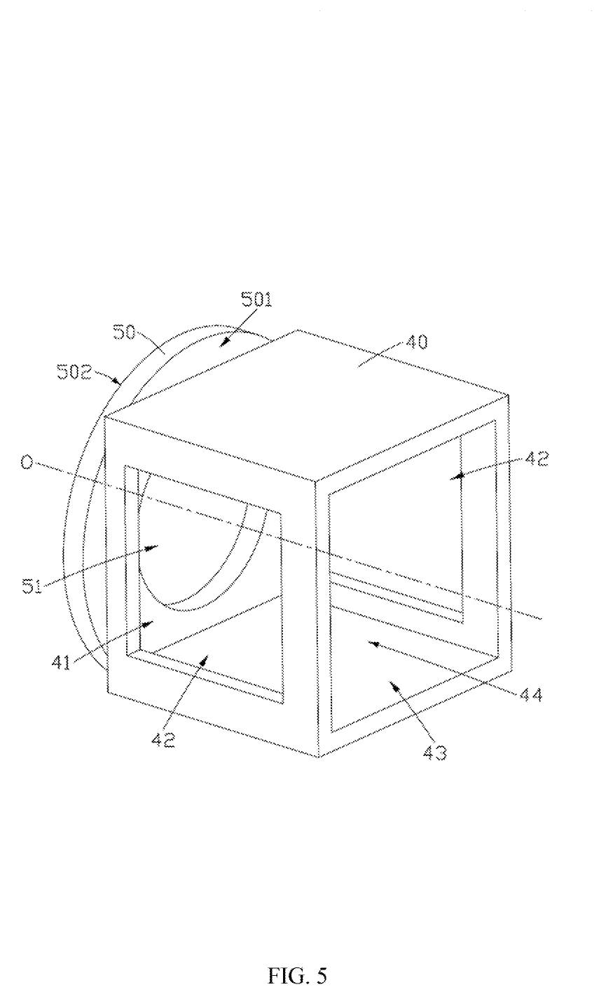

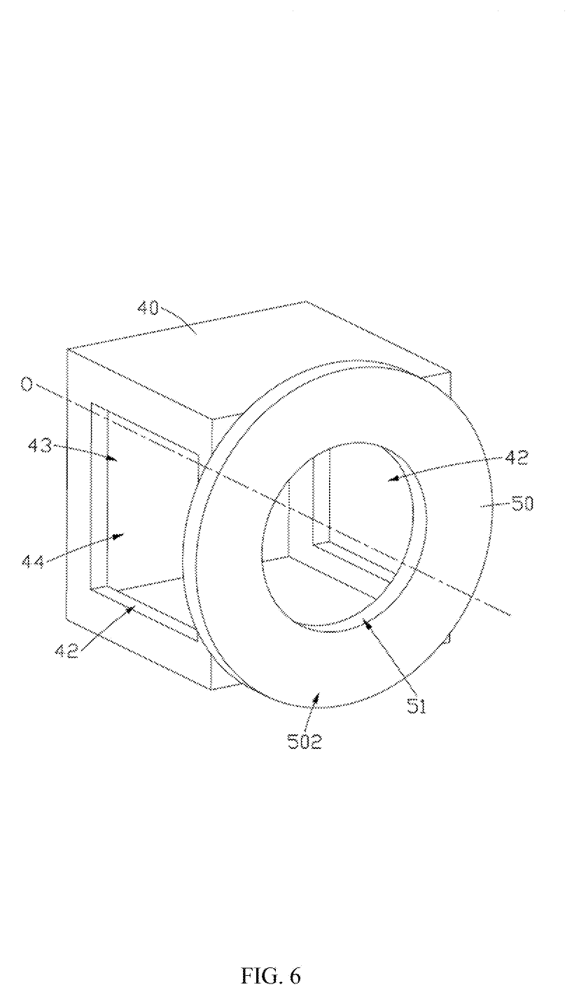

Referring to FIGS. 3, 5 and 6, the first connecting structure 50 may be a circular ring structure, and a shape of the first opening 51 is circular. The first connecting structure 50 includes a first surface 501 and a second surface 502 spaced apart from each other, and the first surface 501 and the second surface 502 are parallel to each other. The first surface 501 is connected to the mounting frame 40, and the second surface 502 is in contact with the lens assembly 30. The first surface 501 and the second surface 502 are perpendicular to the optical axis O of the lens assembly 30. The first opening 51 penetrates the first surface 501 and the second surface 502, so that the first opening 51 is in communication with the light-emitting port 41. The light-emitting surface 201 of the light-combining element 20 is exposed from the light-emitting port 41, so the image light emitted from the light-emitting surface 201 can successively pass through the light-emitting port 41 and the first opening 51 to enter the lens assembly 30.

When assembling the optical engine structure, to ensure that the image light emitted from the display can form a clear image after successively passing through the light-combining element and the lens assembly, a positional relationship among the components in the optical engine structure should meet the following requirements: the optical axis of the lens assembly coincides with the optical axis of the light-combining element, an incident surface of the lens assembly is parallel to the light-emitting surface of the light-combining element, and the center of the display portion of the display aligns with the center of the light-entering surface of the light-combining element, etc. In related technologies, the relative positions of the lens assembly and the display with respect to the light-combining element are generally adjusted by an active alignment (AA) device to meet the above requirements, and then the lens assembly and the display are respectively connected to the light-combining element.

In the optical engine structure 1 of each embodiment of the present application, the lens assembly 30 is engaged and connected with the first connecting structure 50, the first surface 501 of the first connecting structure 50 is connected with the mounting frame 40, and the light-combining element 20 is located in the installation space 44 of the mounting frame 40, the light-emitting surface 201 of the light-combining element 20 is exposed from the light-emitting port 41. Thus, it can be known that the light-combining element 20 is connected with the lens assembly 30 through the mounting frame 40 and the first connecting structure 50, the optical axis of the lens assembly 30 coincides with the optical axis of the light-combining element 20, and the centers of the first opening 51 and the light-emitting port 41 are both on the optical axis O. At this time, the center of the light-emitting surface 201 of the light-combining element 20 is on the optical axis of the lens assembly 30, and the image light emitted from the light-combining element 20 can be modulated by the lens assembly 30 and then emitted to form a clear image.

That is, by reasonably designing a structure of the mounting frame 40 and the first connecting structure 50, the lens assembly 30 and the light-combining element 20 can be simply connected to the mounting frame 40 and the first connecting structure 50 respectively, to meet the requirements that the optical axis of the lens assembly 30 coincides with the optical axis of the light-combining element 20, and the centers of the first opening 51 and the light-emitting port 41 are both on the optical axis O, without the need to adjust the position between the lens assembly 30 and the light-combining element 20 through an active alignment device to meet the above requirements.

Therefore, the embodiment of the present application is conducive to simplifying the assembly process of the optical engine structure 1 and shortening the time for manufacturing the optical engine structure 1.

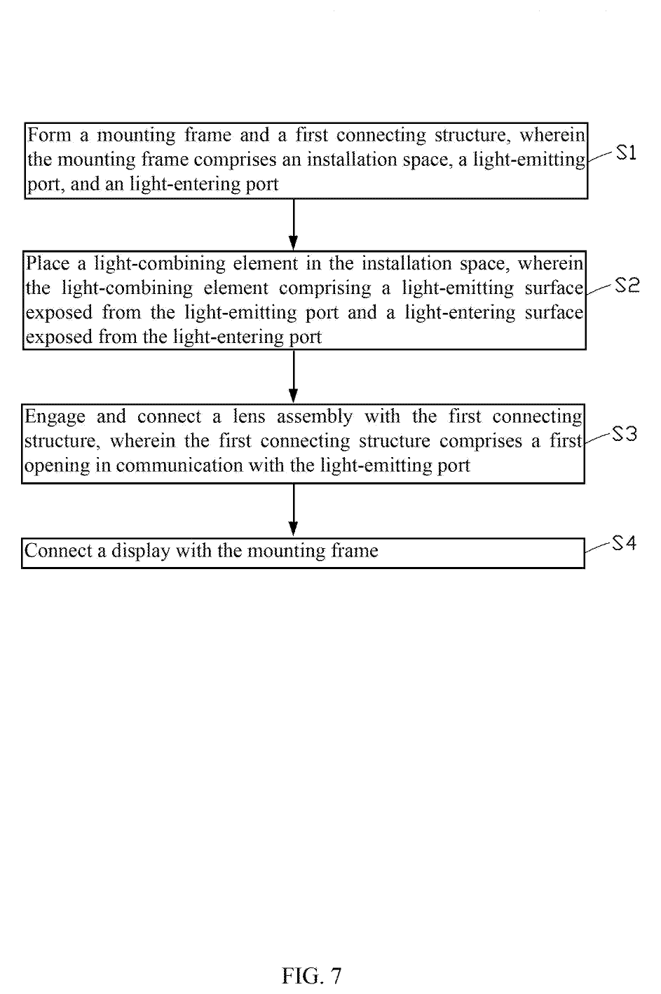

FIG. 7 illustrates a flowchart of an assembly method of an optical engine structure in accordance with an embodiment. The exemplary method is provided by way of example, as there are a variety of ways to carry out the method. Each block shown in FIG. 7 represents one or more processes, methods, or subroutines, carried out in the exemplary method. Furthermore, the illustrated order of blocks is by example only and the order of the blocks can change. Additional blocks may be added or fewer blocks may be utilized, without departing from this disclosure. The exemplary method can begin at block S1.

At block S1, the mounting frame 40 and the first connecting structure 50 are formed through integral molding, an installation space 44, a light-emitting port 41 and an light-entering port 42 are formed on the mounting frame 40, and the light-emitting port 41 and the light-entering port 42 are in communication with the installation space 44.

At block S2, the light-combining element 20 is placed in the installation space 44, the light-emitting surface 201 of the light-combining element 20 is exposed from the light-emitting port 41, and the light-entering surface 202 is exposed from the light-entering port 42.

At block S3, the lens assembly 30 is engaged and connected with the first connecting structure 50, and the first connecting structure 50 has a first opening 51 in communication with the light-emitting port 41.

At block S4, the display 10 is connected with the mounting frame 40.

In block S1, the mounting frame 40 and the first connecting structure 50 are formed through integral injection molding, or through integral metal processing.

An installation port 43 in communication with the installation space 44 may be formed on the mounting frame 40, and an area of the installation port 43 is greater than an area of the light-emitting port 41 and is greater than an area of the light-entering port 42.

In block S2, a step of placing the light-combining element 20 in the installation space 44 includes: assembling the light-combining element 20 into the installation space 44 through the installation port 43; and fixing a second connecting structure 60 at the installation port 43.

A second opening 61 in communication with the installation port 43 is formed on the second connecting structure 60, the area of the installation port 43 is greater than an area of the second opening 61, and the area of the second opening 61 is smaller than an area of a cross-section of the light-combining element 20 perpendicular to the optical axis O, which is conducive to fixing the light-combining element 20 in the installation space 44 and preventing the light-combining element 20 from detaching from the mounting frame 40 during the use of the optical engine structure 1.

After the light-combining element 20 is placed in the installation space 44, the light-emitting surface 201 of the light-combining element 20 is exposed from the light-emitting port 41, and the light-entering surface 202 of the light-combining element 20 is exposed from the light-entering port 42 and the installation port 43.

In block S3, a step of engaging and connecting the lens assembly 30 with the first connecting structure 50 includes: forming a slot 31 on an end of the lens assembly 30 facing the first connecting structure 50, and engaging the first connecting structure 50 into the slot 31.

The first connecting structure 50 includes a first surface 501 and a second surface 502 spaced apart from each other, the first surface 501 is connected to the mounting frame 40, the second surface 502 is in contact with the lens assembly 30, and the first surface 501 and the second surface 502 are perpendicular to the optical axis O of the lens assembly 30. The first opening 51 penetrates through the first surface 501 and the second surface 502, allowing the first opening 51 to be in communication with the light-emitting port 41. The light-emitting surface 201 of the light-combining element 20 is exposed from the light-emitting port 41, so that the image light emitted from the light-emitting surface 201 can pass through the light-emitting port 41 and the first opening 51 in sequence and enter the lens assembly 30.

In block S4, before the step of connecting the display 10 with the mounting frame 40, it includes: using an active alignment device to adjust a position between a display portion 11 of the display 10 and the light-combining element 20, so that the center of the display portion 11 is aligned with the center of the light-combining element 20.

The display 10 further includes a circuit board 12 and a connector portion 13. One end of the circuit board 12 is electrically connected to the display portion 11, and another end of the circuit board 12 is electrically connected to the connector portion 13. The connector portion 13 is electrically connected to an external power supply or a signal source to input electrical signals to the display portion 11, thereby enabling the display portion 11 to emit image light.

Compared with adjusting the position between the lens assembly 30 and the light-combining element 20 using an active alignment device and then connecting the lens assembly 30 and the light-combining element 20, the assembly method of the above-mentioned optical engine structure 1 simplifies the assembly process of the optical engine structure 1 and shortens the time for manufacturing the optical engine structure 1 by reasonably designing and manufacturing the mounting frame 40 and the first connecting structure 50, and simply docking the lens assembly 30 and the light-combining element 20 with the mounting frame 40 and the first connecting structure 50 respectively.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. An optical engine structure comprising:
a display for emitting image light;
a light-combining element configured for receiving the image light and changing an optical path of the image light and comprising a light-emitting surface and a light-entering surface;
a lens assembly located on a side of the light-combining element having the light-emitting surface and configured for modulating the image light from the light-emitting surface and emitting the image light after the image light is modulated;
a mounting frame comprising an installation space, a light-emitting port, and a light-entering port, wherein the light-emitting port and the light-entering port are in communication with the installation space, the light-combining element is located in the installation space, the light-emitting surface is exposed from the light-emitting port, the light-entering surface is exposed from the light-entering port; and
a first connecting structure fixedly connected to the light-emitting port of the mounting frame, wherein the first connecting structure comprises a first opening in communication with the light-emitting port, the first connecting structure is engaged with the lens assembly, an optical axis of the lens assembly coincides with an optical axis of the light-combining element, and a center of the first opening and a center of the light-emitting port are both located on the optical axis of the lens assembly.

2. The optical engine structure of claim 1, wherein the first connecting structure further comprises a first surface and a second surface spaced apart from each other, and the first surface is connected to the mounting frame, and the second surface is in contact with the lens assembly, and the first surface and the second surface are perpendicular to the optical axis of the lens assembly.

3. The optical engine structure of claim 2, wherein the first opening penetrates the first surface and the second surface.

4. The optical engine structure of claim 1, wherein a shape of the first opening is circular.

5. The optical engine structure of claim 1, wherein an end of the lens assembly facing the first connecting structure comprises a slot, and the first connecting structure is engaged in the slot.

6. The optical engine structure of claim 5, wherein a shape of the slot is annular.

7. The optical engine structure of claim 1, wherein the mounting frame further comprises an installation port in communication with the installation space, and an area of a cross-section of the light-combining element perpendicular to the optical axis of the lens assembly is equal to an area of the installation port.

8. The optical engine structure of claim 7, wherein the optical engine structure further comprises a second connecting structure, the second connecting structure is fixedly connected to the installation port and comprises a second opening in communication with the installation port, and an area of the second opening is less than the area of the installation port.

9. The optical engine structure of claim 1, wherein the light-emitting port is rectangular.

10. The optical engine structure of claim 1, wherein the mounting frame is integrally formed with the first connecting structure.

11. An assembly method of an optical engine structure comprising:
forming a mounting frame and a first connecting structure, wherein the mounting frame comprises an installation space, a light-emitting port, and an light-entering port;
placing a light-combining element in the installation space, wherein the light-combining element comprising a light-emitting surface exposed from the light-emitting port and a light-entering surface exposed from the light-entering port;
engaging and connecting a lens assembly with the first connecting structure, wherein the first connecting structure comprises a first opening in communication with the light-emitting port, the first opening is configured for allowing the image light from the first element that passes through the light-emitting port to pass through and enter the lens assembly; and
connecting a display with the mounting frame.

12. The assembly method of the optical engine structure of claim 11, wherein the mounting frame and the first connecting structure are formed by integral injection molding or by integral metal processing.

13. The assembly method of the optical engine structure of claim 12, wherein when the mounting frame and the first connecting structure are formed by integral injection molding, an installation port in communication with the installation space is formed on the mounting frame, an area of the installation port is greater than an area of the light-emitting port, and the area of the installation port is greater than is greater than an area of the light-entering port.

14. The assembly method of the optical engine structure of claim 13, wherein a step of placing the light-combining element in the installation space comprises:
assembling a light-combining element into the installation space through the installation port; and
fixing a second connecting structure at the installation port, wherein the second connecting structure comprises a second opening in communication with the installation port, an area of the second opening is less than the area of the installation port.

15. The assembly method of the optical engine structure of claim 11, wherein a step of engaging and connecting the lens assembly with the first connecting structure comprises:
forming a slot on an end of a lens assembly; and
engaging the first connecting structure into the slot.
